(19) United States
(12) Patent Application Publication
(10) Pub. No.: US 2005/0226974 A1
(43) Pub. Date: Oct. 13, 2005

(54) Natamycin dosage form, process for preparing same, method for preserving a food product and preserved food product

(76) Inventors: John Faragher, Richfield, WI (US); Bo Torang, Grindsted (DK); Samuel Bech, Grindsted (DK); Linda Valerie Thomas, Dorchester (GB); Kersti Haugan, Vejle (DK)

Correspondence Address: STEPTOE & JOHNSON LLP;Attn: Docket Administrator - Box USPTO, 1330 Connecticut Avenue, NW, Washington, DC, 20036, US

(21) Appl. No.: 10/820,145

(22) Filed: Apr. 8, 2004

(51) Int. Cl. A23K 1/00

(52) U.S. Cl. 426/335

(57) ABSTRACT

The invention relates to a natamycin dosage form comprising a tablet, which consists of physiologically acceptable components, said tablet containing an effective food preserving amount of natamycin. The invention also relates to a process for producing such a dosage form as well as to a method for preservation of a food product comprising adding natamycin contained in a natamycin dosage form directly or indirectly to a food product to provide a preserving amount of natamycin in said food product.

### FIELD OF THE INVENTION

The present invention relates to natamycin dosage forms for the food and feed industry, and more particularly to tablets containing natamycin. The present invention relates also to novel processes for preparing the tablets according to the invention and methods for preserving food products as well as to preserved food products.

### BACKGROUND OF THE INVENTION

Natamycin is a polyene macrolide natural anti-fungal agent produced by fermentation of the bacterium Streptomyces natalensis. Natamycin (previously known as pimaricin) has an extremely effective and selective mode of action against a very broad spectrum of common food spoilage yeasts and moulds with most strains being inhibited by concentrations of 1-15 ppm of natamycin.

Natamycin has been used for many years in a many countries throughout the world as an authorized preservation treatment, principally for surface treatment of cheeses and certain meat products such as dried sausages. Despite this long-term use, the development of resistant strains has not been reported to date unlike the chemical organic acid sorbate and propionate preservatives for which a number of resistant yeasts and moulds have been detected and reported. Some species of Penicillium mould are even able to degrade and metabolise sorbate.

Natamycin is much less soluble in water than the chemical organic acid preservatives, with its maximum solubility being around 40 ppm. In practice this means that when applied to the surface of the cheese or sausage, natamycin is mainly present in the form of crystals on the surface. The dissolved fraction of natamycin shows very limited diffusion into the food.

Natamycin is active over a wide pH range and unlike the organic acid preservatives it is not dependent on a low pH acidic environment to show good anti-fungal activity. Natamycin has not been reported to have any adverse quality or flavour impact on food products. Natamycin is most soluble at high or low pH but is most stable at neutral pH (Stark, J., and Tan, H. S. 2003. ‘Natamycin’. In: Food Preservatives, Second Edition. Eds: N.J. Russell and G. W. Gould. Kluwer Academic/Plenum Publishers.)

A general description of natamycin and its current uses may be found in the above review and in Thomas, L. V. and Delves-Broughton, J. 2003. Natamycin. in: Encyclopedia of Food Sciences and Nutrition. Eds. B. Caballero, L. Trugo and P. Finglas, pp 4109-4115. Elsevier Science Ltd.

U.S. Pat. No. 5,196,344 describes a solid antimicrobial composition for the preservation of milk samples, which comprises a mixture of 2-bromo-2-nitropropane-1,3 diol and natamycin in a ratio by weight of about 10-40:1. This composition is preferably in a form of a tablet. The tablets of the publication contain only small amounts of natamycin. The tablets are not suitable for use in products intended for food use and they may also contain a colouring agent to prevent accidental ingestion of treated milk. 2-bromo-2-nitropropane-1,3 diol is a toxic compound that cannot be used in food products.

DE 10208335 describes production of pharmaceutical tablets using a copolymer of methacrylic acid and methyl acrylate as a coating or binder. The therapeutically active ingredient in the tablet may be natamycin.

The following articles disclose tablets containing natamycin for oral and vaginal use: Gehring, W., Spate, W., Gehse, M., Gloor, M., Braun, K. J. 1990. Results of a combined treatment with natamycin and butylscopolamine in cases of intestinal Candida colonization; Walczak, M. 1987. Evaluation of the effectiveness of natamycin in the treatment of diabetic children with infections caused by Candida albicans. Current Therapeutic Research 40: 1029-1033; Buch, A., Christensen, E. S. 1982. Treatment of vaginal candiosis with natamycin and effect of treating the partner at the same time. 1982. Acta Obstetricia et Gynecologica Scandinavica 61: 393-396; Brzeski, J., Kretowicz, J. 1982. Treatment of vaginal mycosis in pregnant women with pimafucin. 1982. Ginekologia Polska 53: 177-179; Kejda, J. and Hatala, M. 1978. Therapy and prevention of oral candidoses with natamycin. Casopis Lekaru Ceskych 117: 880-883; Ainsworth, J W L., Mellor, G P, Rutherfors, A M. 1980. Clinical efficacy of pimafucin vaginal tablets in a ten-day course for vaginal candidiasis. NZ Medical Journal 91: 420-421; Toth, B. et al. 1971. Analysis of clinical and laboratory findings in pimafucin-treated colpitis caused by yeasts and mixed infections. Zentralblatt fur Gynakologie 93: 1560-1567 and Laskonicka, Z et al. 1971. Pimaricin in the treatment of superficial fungal infections in children. Acta Paediatricia Scandinavica 60: 456-460

U.S. Pat. No. 5,962,510 discloses an antifungal composition comprising polyene fungicide, a suitable thickener and optionally salt. The polyene fungicide of the publication is e.g. natamycin. U.S. Pat. No. 5,552,151 discloses a concentrated suspension of polyene fungicides such as natamycin which exhibits good chemical, microbial and physical stability.

Documents cited in this text (“herein cited documents”), as well as each document or reference cited in each of the herein-cited documents, and all regulations, manufacturer's literature, specifications, instructions, product data sheets, material data sheet, and the like, as to each product mentioned in this text, are hereby expressly incorporated herein by reference.

In the food industry natamycin is generally used as a suspension in an aqueous solution used for the surface treatment of food (i.e. in spraying, dipping and painting with a brush) or dosed as a powder directly into food. The natamycin powder, although mixed with excipients such as lactose, is difficult to handle due to its stickiness. Furthermore it causes problems by the dust it generates and it can also adhere to weighing equipment. The powder is also easy to spill. Since natamycin is very potent and is effective at very low doses (minimal inhibitory concentrations for some yeasts can be less than 3 ppm) such handling problems could result in significant economic losses. In addition, such natamycin may adversely affect the processing of the products that it is intended to preserve.

It is normally recommended that salt should be added to natamycin surface treatment suspensions in order to prevent their bacterial contaminations whilst they are stored at room temperature. Addition of salt, however, involves extra labour, requires storage space, and the salt causes corrosion of equipment as well as clogging of the spray nozzles where it may crystallize.

Natamycin is a very attractive antifungal agent for many purposes in the food and feed industry. However, its physical handling and dosing is not altogether uncomplicated particularly because of its potency at very low concentrations. There is thus a need to facilitate the handling and dosing of natamycin in the food and feed industry.

Natamycin dosage forms for the food industry need to have a high potency compared to pharmaceutical products. Producing high potency natamycin tablets is difficult because of the poor flowability of natamycin. Tablets for the food industry also need to have good friability and disintegration. The natamycin content of the known oral and vaginal tablets is low, and therefore natamycin has not caused such problems during such tabletting procedures.

There is a need to provide a natamycin dosage form that is easy for the food manufacturers to handle, which has good friability (i.e. the tablets do not break up during transport and storage) and good disintegration (i.e. the tablets disintegrate rapidly in a solution with minimum agitation, fully releasing natamycin into the suspension and leaving no debris). The natamycin dosage form also needs to contain a high enough amount of natamycin for food preservation purposes.

The present invention seeks to overcome the problems of the known natamycin dosage forms, as described above, by providing tablets which have good friability and good disintegration and which are easy to handle.

### BRIEF SUMMARY OF THE INVENTION

Natamycin tablet formulations are known in the pharmaceutical field. However, natamycin tablets for use in preserving edible food products have not been previously suggested. The present invention overcomes the problems encountered in the food industry in the dosing and handling of natamycin for food preservation. The invention relates to a specific process and formulation for producing natamycin tablets that facilitate their preparation, facilitate their use in the food and feed industry and ensure that such tablets rapidly and fully disintegrate when added to a liquid vehicle. Natamycin in a tablet form according to the present invention results in better ease of handling. It is easier to measure accurate amounts of the preservative, and it creates less dust, improving the safety of the food processing personnel and reducing economic losses compared to the prior art methods of dosing natamycin for the preservation of edible food. The present invention also overcomes the problems caused by the poor flowability of natamycin as well as the poor friability associated with natamycin tablets.

A further aspect of the invention is the development of natamycin tablets containing a buffer providing acidic pH to improve natamycin solubility in order to reduce the risk of spray nozzle blocking due to undissolved natamycin crystals (e.g when used for the surface spray of shredded cheese), and also to reduce the risk of bacterial contamination of the treatment suspension. The acidic pH eliminates the need to add 10% salt with its associated storage and corrosion problems.

The natamycin tablets of the present invention may further contain food grade antibacterial agents, thickeners and/or emulsifiers.

An object of the present invention is thus to provide a natamycin dosage form comprising a tablet, which consists of physiologically acceptable components, said tablet containing an effective food preserving amount of natamycin.

An object of the invention is also a process for producing a natamycin dosage form comprising the steps of mixing particles comprising natamycin with a free-flowing agent and physiologically acceptable component(s), feeding said mixture into a tabletting machine and forming said mixture into a tablet which consists of physiologically acceptable components and an effective food preserving amount of natamycin.

A further object of the invention is a method for the preservation of a food product comprising adding natamycin contained in a natamycin dosage form, which comprises a tablet consisting of physiologically acceptable components and containing an effective food preserving amount of natamycin, directly or indirectly to said food product to provide a preserving amount of natamycin in or on the surface of said food product. A further object of the invention is also preserved food products. Such a food product comprises a preserved food product prepared by adding thereto, directly or indirectly, an effective food preserving amount of natamycin derived from a tablet according to the present invention.

The objects of the invention are achieved by the tablets, processes and methods as well as preserved food products defined in the independent claims. Preferred embodiments of the invention are disclosed in the dependent claims.

The natamycin dosage form is preferably a tablet containing between 5 and 50% by weight natamycin, more preferably 10 to 40% natamycin, most preferably from 15 to 30% natamycin.

The tablet additionally contains excipient(s) selected from a diluent, a binding agent, a disintegrating agent, a free-flowing agent, an anti-caking agent, a tabletting agent and/or a lubricant. Preferred excipient(s) are selected from a diluent, a binding agent, a disintegrating agent, a free-flowing agent, an anti-caking agent, a tabletting agent and/or a lubricant. The most preferred excipient is selected from the group consisting of microcrystalline cellulose, lactitol, glucose, lactose, sucrose, fructose and sodium chloride. The most preferred excipient is microcrystalline cellulose.

The tablet contains preferably from 50 to 80% by weight of a free-flowing agent.

The tablet preferably has a disintegration in an aqueous solution at 25° C. of less than 350 seconds measured according to the US Pharmacopoeia 27. p. 2302 (701). The tablet preferably has a friability of less than 5% measuread according to the US Pharmacopoeia 27. p. 2621 (1216).

In one embodiment of the invention the tablet further comprises a buffer. The buffer is preferably citrate and/or phosphate. The pH of such a suspension is about 3.5 to about 6.5. In another embodiment of the invention the tablet further comprises a food grade antibacterial agent, a thickener and/or an emulsifier.

The tablet is adapted for being disintegrated in an aqueous solution to provide a natamycin suspension with an effective amount of natamycin for spraying onto an edible foodstuff or for dipping an edible food product in or for painting the surface of a food product with a brush. In an alternative embodiment of the present invention the tablet is adapted for being added directly into a liquid food product such as various drinks.

The tablet of the present invention is preferably also used for providing a suspension for the surface treatment of food products. The tablet is suspended in a liquid vehicle to provide a natamycin suspension with an effective amount of natamycin for spraying or painting onto an edible foodstuff or for dipping an edible food product in. The suspension preferably contains 0.125-0.25% natamycin. In a preferred embodiment the tablet is first disintegrated in aqueous solution and then used for the surface treatment. The suspension is preferably also free from nutrients easily metabolisable by bacteria.

The food product preserved by this method is preferably selected from cheese, shredded cheese, processed cheese, cream cheese, sour cream, dried fermented meat product including salamis and other sausages, wine, beer, yoghurt, juice and other beverages, salad dressing, dips, bakery products and bakery fillings, surface glazes and icing, pizza toppings, confectionery and confectionery fillings, olives, olive brine, olive oil, cottage cheese, cottage cheese dressing, tomato purees and paste, condiments, and fruit pulp and the like food products, as well as feed products, such as pet food, broiler feed etc.

### BRIEF DESCRIPTION OF THE DRAWING

FIG. 1 discloses the rate of spoilage in different natamycin suspensions at 20° C.

### DETAILED DESCRIPTION OF THE INVENTION

The present invention relates to a natamycin dosage form comprising a tablet, which consists of physiologically acceptable components, said tablet containing an effective food preserving amount of natamycin. The present invention also relates to a process for producing a natamycin dosage form comprising the steps of mixing particles comprising natamycin with a free-flowing agent and physiologically acceptable component(s), feeding said mixture into a tabletting machine, forming said mixture into a tablet which consists of physiologically acceptable components and an effective food preserving amount of natamycin.

The present invention also provides a method for preservation of a food product comprising adding natamycin contained in a natamycin dosage form which comprises a tablet consisting of physiologically acceptable components and containing an effective food preserving amount of natamycin, directly or indirectly to said food product to provide a preserving amount of natamycin in said food product.

The term “physiologically acceptable” as used here means that the components which are used in the tablets are acceptable in edible food products and that they contain only food grade components. The term “an effective food preserving amount” means that the amount of natamycin added in or on the food product is so high that it prevents mould or yeast spoilage of the food product.

The tablet formulation of the present invention provides a tablet suitable for use in the preservation of the food products in the food industry. The term “food” as used in this text includes both food and feed. The tablet overcomes the problems encountered in handling the natamycin powder and the problems of preparing natamycin tablets caused by the poor flowability of natamycin as well as the poor friability associated with such tablets.

The natamycin tablets of the present invention are prepared using conventional tabletting machines. In a preferred embodiment of the invention the tabletting is performed using a tablet pressing machine. Use of an effective free flowing agent in the preparation of the tablets enables the production of natamycin tablets which contain a sufficient amount of natamycin to be used in food products for their preservation.

All the components of the tablets are physiologically acceptable, and therefore the tablets are acceptable to be used in food products. The components of the tablet are first mixed together and then fed into the tabletting machine. The free flowing agent used improves the flowability of the mixture enabling tabletting, so that the mixture is does not block the tabletting machine even if the natamycin content is high. The tablet contains preferably from 50 to 80% by weight of a free-flowing agent, preferably microcrystalline cellulose.

The amount of natamycin in the tablet is determined by the desired use. However, the natamycin content has to be large enough to provide a preserving effect in or on the food product to which it is added. The large amount of natamycin in the tabletting mixture makes the tabletting difficult, so the choice of the free flowing agent also affects the amount of natamycin which can be incorporated into the tablet. The natamycin tablet preferably contains between 5 and 50% by weight natamycin, more preferably 10 to 40% natamycin, most preferably from 15 to 30% natamycin.

The other components used in the tablet depend on the desired properties of the tablet. The tablet may additionally contain excipient(s) selected from a diluent, a binding agent, a disintegrating agent, a free-flowing agent, an anti-caking agent, a tabletting agent and/or a lubricant. These excipients are chosen depending on the desired properties of the tablet, however all the excipients have to be physiologically acceptable, in order to allow the use of the tablets in food products. The disintegrating agent used in the present invention provides good disintegration of the tablet in a liquid. The free flowing agent and the disintegrating agent used in the present invention may be two separate agents or an agent which provides both these properties. Preferred excipients are selected from the group consisting of microcrystalline cellulose, lactitol, glucose, lactose, sucrose, fructose and sodium chloride. An especially preferred free flowing agent and disintegrating agent comprises microcrystalline cellulose, which provides both these properties.

The tablets of the present invention have a good disintegration and therefore they are easy to suspend into a liquid vehicle making all the natamycin in the tablet available for biological activity and effective when used. The preferred tablet has a disintegration in an aqueous solution at 25° C. of less than 350 seconds. The disintegration means that the tablets disintegrate rapidly in solution with minimum agitation fully releasing natamycin into suspension and leaving no debris. The disintegration is measured by a standard method described in US Pharmacopoeia 27. page 2302 (701). In this method 6 tablets are placed in a thread basket and the basket is moved up and down in water at 25° C. and the time is measured for the tablet to disintegrate and disappear through the threads.

The friability of the preferred tablet is good as well, so it does not break before use. The friability is preferably less than 5%. Good friability means that the tablets do not break up during transport and storage. The friability is measured by a standard method described in US Pharmacopoeia 27 page 2621 (1216). In this method 10 tablets are placed in a plastic cylinder which is then rotated 100 times. The tablets are weighed before and after the rotation.

The natamycin tablets of the present invention are easy to handle in the food industry since it is possible to get an exact amount of natamycin by adding the tablet(s) to the food product directly or indirectly. Each tablet contains a specific amount of natamycin, and therefore there is no need for separate weighing of the natamycin.

The method for preservation of a food product according to the present invention comprises adding the natamycin tablet directly or indirectly to the food product to provide a preserving amount of natamycin in said food product or on the surface of said food product.

In the direct use the tablet is added as such to a liquid or semi-liquid food product. The tablet disintegrates in the food product and provides an effective and available amount of natamycin therein to prevent spoilage. The tablet can be added directly to any food product wherein the tablet disintegrates. Such food products are for instance wine, beer, yoghurt, juice and other beverages, salad dressing, dips, bakery fillings, confectionery fillings, surface glazes and icing, sour cream, olives, olive brine, olive oil, tomato purees and paste, condiments, fruit pulp, pet food, etc.

The tablet of the present invention can also be used indirectly in the food products. In such a case the tablet is first disintegrated or suspended in a liquid, such as water, ethanol etc. to provide a natamycin suspension with an effective amount of natamycin. This suspension is then used as a spray suspension and sprayed onto an edible foodstuff. It is also possible to use the suspension as a dipping suspension, in which case the edible food product is dipped into the suspension. The suspension may also be painted with a brush on the food product. The tablet is thus used in surface treatment of the food product. The food product preserved by this method is preferably selected from cheese, shredded cheese processed cheese, cream cheese and dried fermented meat product such as salami and other sausages, bakery product and bakery fillings, surface glazes and icing, pizza toppings, confectionery, olives, cottage cheese and cottage cheese dressing.

The tablet of the present invention provides an easy way of preparing the spraying, dipping or painting suspension. The necessary amount of tablets is easily added to the liquid and disintegrated in it, since there is no need for weighing the natamycin in powder form.

The suspension made of the natamycin tablet preferably contains 0.125-0.25% natamycin.

The natamycin tablet of the present invention also enables the provision of suspensions, which are substantially free from nutrients easily metabolisable by bacteria. If the natamycin tablet is made without components suitable as nutrients easily metabolisable by bacteria, the natamycin suspension can be preserved without addition of 10% salt.

A further aspect of the invention is the development of natamycin tablets containing a buffer which provides acidic pH to a solution. This improves natamycin solubility and reduces the risk of spray nozzle blocking due to undissolved natamycin crystals (e.g for the surface spray of shredded cheese). In such a case the tablet further comprises a buffer that controls the pH of the suspension. The pH of the suspension is preferably lowered to 3.5 to 6.5 using the buffer. The buffer is preferably citrate and/or phosphate. In case citric acid is used, 7-14% citric acid provides a pH of about 4 to the suspension. Natamycin dissolves better in acidic solutions, and therefore the buffer included in the tablet makes the natamycin in the tablet more soluble. At higher pH values the natamycin may settle down in the suspension. Thus, the suspension made from the tablet containing buffer makes a natamycin suspension which will cause less nozzle blocking.

The tablet according to the present invention may further comprise an antibacterial agent, a thickener and/or an emulsifier. The antibacterial agent included in the tablet of the present invention preferably prevents the bacterial growth in the suspension made using the tablet. A suitable antibacterial agent is e.g. nisin. A thickener or an emulsifier is optionally also included in the tablet. The thickener improves the distribution of the natamycin compound over the surface of the food product and it also prevents dripping of the suspension after the application as well as speeds up the drying of the suspension. It also makes the suspension physically stable. A suitable thickener is e.g xanthan. An emulsifier included in the tablet improves the stability of the natamycin suspension made from the tablet by keeping the components evenly distributed in the suspension. A suitable emulsifier of the present invention is e.g. monolaurin.

It is also possible to use the tablet in an aqueous suspension containing buffer, thickener, emulsifier and/or antibacterial agent. The component may be added into the suspension either before or after the addition of the tablet.

The following examples illustrate the invention.

### EXAMPLE 1

A tablet according to the present invention was prepared in a tablet pressing machine. The tablet contained the following components:
4000.0 g Avicel® (microcrystalline cellulose; Degussa)
1000.0 g Natamax™-SF (87% active natamycin, Danisco A/S)
25.0 g Aerosil® (silica compound, tabletting agent; FMC Biopolymer)
17.5 g Mg stearate

The following properties of the tablet were tested:
Disintegration was 60 seconds (in 25° C. water)
Friability (hardness) was 0.1%
Weight; 0.902 g/tab

The natamycin content of the tablet was 0.156 g, i.e. 17.3% as active natamycin.

The tablet had good disintegration and friability and there were no problems while tabletting.

### EXAMPLE 2

A tablet prepared in the Example 1 was used in trials for comparison of spoilage. The trials compared the following natamycin preparations:
Natamax™ (50% active natamycin blended with lactose; Danisco A/S)
Natamax™ Tab (17.3% active natamycin in a tablet form; Danisco A/S)
Natamax™ SF (87% active natamycin; Danisco A/S)

The following suspension were made and tested for the prevention of bacterial growth.

| | | Natamycin | |
|---|---|---|---|
| | | content of | |
| Description | Preparation | suspension | pH |
| Control | 100 ml water | 0% | 7.35 |
| Natamax ™ Tab | 4 natamycin tablets (Natamax ™ | 0.25% | 7.55 |
| | Tab) in 250 ml water | | |
| Natamax ™ Tab, | 4 natamycin tablets (Natamax ™ | 0.25% | 4.06 |
| pH 4 | Tab) in 250 water adjusted to | | |
| | pH 4 | | |
| Natamax ™ Tab + | 4 natamycin tablets (Natamax ™ | 0.25% | 7.26 |
| 10% salt | Tab) + 25 g salt in 225 ml water | | |
| Natamax ™ | 0.5 g Natamax ™ in 100 ml | 0.25% | 8.21 |
| | water | | |
| Natamax ™ + | 0.5 g Natamax ™ + 25 g salt | 0.25% | 7.09 |
| 10% salt | in 75 ml water | | |
| Natamax ™-SF | 0.287 g Natamax ™-SF in 100 | 0.25% | 8.14 |
| | ml water | | |
| Natamax ™-SF + | 0.287 g Natamax ™-SF + 25 g | 0.25% | 6.97 |
| 10% salt | salt + 75 ml water | | |

In non-sterile containers, natamycin suspensions were prepared as above using normal tap water. One suspension using the natamycin tablets was adjusted to pH 4 by minimum addition of 5 M HCl. The natamycin suspensions were stored at ambient temperature (approx. 20° C.) and analysed microbiologically by viable count enumeration at regular intervals. Samples were shaken at every sampling time.

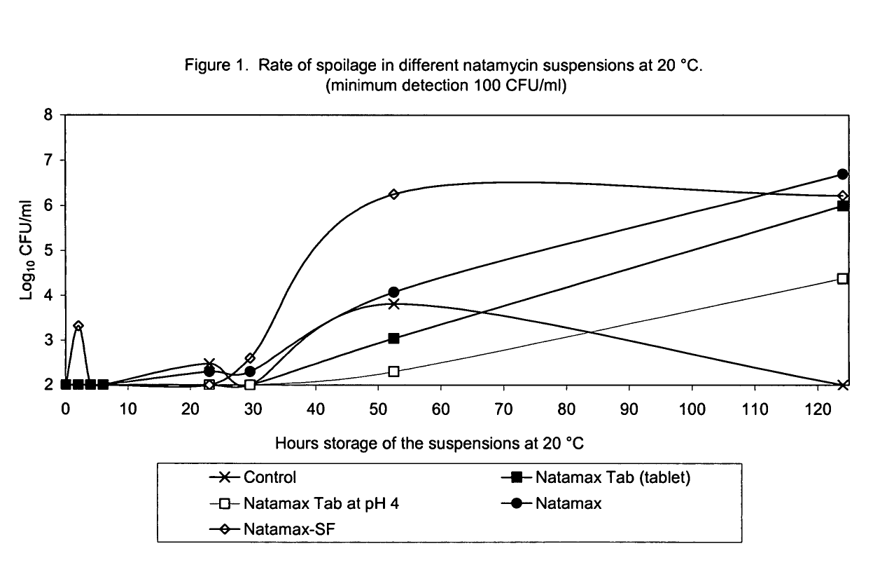

The tablets disintegrated instantly and the disintegration was good. The natural contaminant bacteria that grew in the suspensions were mainly a mixture of Gram-negative species. The addition of 10% salt completely inhibited contaminant growth in every case. FIG. 1 shows the growth of natural contaminant bacteria in the different suspensions prepared without salt. FIG. 1 shows that growth of natural contaminant bacteria was faster in natamycin suspensions prepared with natamycin blended with lactose (Natamax™) and the 87% natamycin preparation (Natamax™-SF) compared to suspensions prepared with natamycin in the form of a tablet (Natamax™ Tab). The growth was slowed still further in a natamycin treatment suspension prepared with a natamycin tablet (Natamax™ Tab) adjusted to pH 4.

Based on the description and examples a person skilled in the art is able to apply the invention to a wide variety of food products.

1. A natamycin dosage form comprising a tablet, which consists of physiologically acceptable components, said tablet containing an effective food preserving amount of natamycin.

2. A natamycin dosage form according to claim 1, wherein said tablet contains between 5 and 50% by weight natamycin.

3. A natamycin dosage form according to claim 2, wherein said tablet contains from 10 to 40% natamycin.

4. A natamycin dosage form according to claim 3, wherein said tablet contains from 15 to 30% natamycin.

5. A natamycin dosage form according to claim 1, wherein said tablet additionally contains excipient(s) selected from a diluent, a binding agent, a disintegrating agent, a free-flowing agent, an anti-caking agent, a tabletting agent, a lubricant and mixtures thereof.

6. A natamycin dosage form according to claim 5, wherein said excipient is selected from the group consisting of microcrystalline cellulose, lactitol, glucose, lactose, sucrose, fructose and sodium chloride.

7. A natamycin dosage form according to claim 5, wherein said free-flowing agent and disintegrating agent comprises microcrystalline cellulose.

8. A natamycin dosage form according to claim 5, wherein said tablet contains from 50 to 80% by weight of a free-flowing agent.

9. A natamycin dosage form according to claim 8, wherein said tablet has a disintegration in an aqueous solution at 25° C. of less than 350 seconds, and a friability of less than 5%.

10. A natamycin dosage form according to claim 1, wherein said tablet further comprises a buffer.

11. A natamycin dosage form according to claim 10, wherein said buffer is selected from citrate, phosphate and mixtures thereof.

12. A natamycin dosage form according to claim 1, wherein said tablet further comprises a component selected from a food grade antibacterial agent, thickener, emulsifier and mixtures thereof.

13. A natamycin dosage form according to claim 1, wherein said tablet is adapted for being disintegrated in an aqueous solution to provide a natamycin suspension with an effective amount of natamycin for spraying or painting onto an edible foodstuff or for dipping an edible food product in.

14. A process for producing a natamycin dosage form comprising the steps of
mixing particles comprising natamycin with a free-flowing agent and disintegrating agent and physiologically acceptable component(s)
feeding said mixture into a tabletting machine
forming said mixture into a tablet which consists of physiologically acceptable components and an effective food preserving amount of natamycin.

15. A process according to claim 14, wherein said tabletting is performed using a tablet pressing machine.

16. A process according to claim 14, wherein said tablet contains between 5 and 50% by weight natamycin.

17. A process according to claim 16, wherein said tablet contains from 10 to 40% natamycin.

18. A process according to claim 17, wherein said tablet contains from 15 to 30% natamycin.

19. A process according to claim 14, wherein said tablet additionally contains excipient(s) selected from a diluent, a binding agent, a disintegrating agent, a free-flowing agent, an anti-caking agent, a tabletting, a lubricant and mixtures thereof.

20. A process according to claim 19, wherein said excipient is selected from the group consisting of microcrystalline cellulose, lactitol, glucose, lactose, sucrose, fructose and sodium chloride.

21. A process according to claim 19, wherein said free-flowing agent and disintegrating agent comprises microcrystalline cellulose.

22. A process according to claim 21, wherein said tablet contains from 50 to 80% by weight of a microcrystalline cellulose.

23. A process according to claim 22, wherein said tablet has a disintegration in an aqueous solution at 25° C. of less than 350 seconds and a friability of less than 5%.

24. A method for preservation of a food product comprising adding natamycin contained in a natamycin dosage form which comprises a tablet consisting of physiologically acceptable components and containing an effective food preserving amount of natamycin, directly or indirectly to said food product to provide an effective preserving amount of natamycin in or on said food product.

25. A method according to claim 24, wherein said tablet is added directly into said food product.

26. A method according to claim 24, wherein said tablet is used in surface treatment of said food product.

27. A method according to claim 24, wherein said tablet is suspended in a liquid vehicle to provide a natamycin suspension with an effective amount of natamycin for spraying or painting onto an edible foodstuff or for dipping an edible food product in.

28. A method according to claim 27, wherein said suspension contains 0.125-0.25% natamycin.

29. A method according to claim 27, wherein said suspension is free from nutrients easily metabolisable by bacteria.

30. A method according to claim 27, wherein said tablet is first disintegrated in an aqueous solution and then used as a spray, a dipping or a surface painting suspension.

31. A method according to claim 24, wherein said tablet further comprises a buffer.

32. A method according to claim 24, wherein said buffer is selected from citrate, phosphate and mixtures thereof.

33. A method for preservation of a food product according to claim 31 wherein the pH of said suspension is about 3.5 to about 6.5.

34. A method for preservation of a food product according to claim 24, wherein said tablet further comprises a component selected from a food grade antibacterial agent, thickener, emulsifier and mixtures thereof.

35. A method according to claim 24, wherein said food product is selected from cheese, shredded cheese, processed cheese, cream cheese, sour cream, dried fermented meat product, such as salami and other sausages, wine, yoghurt, juice and other beverages, salad dressing, dips, confectionery, confectionery fillings, surface glazes and icing, bakery product, bakery fillings, pizza toppings, olives, olive brine, olive oil, tomato purees and paste, condiments, cottage cheese, fruit pulp, pet food and broiler feed.

36. A preserved food product comprising natamycin from a tablet which consists of physiologically acceptable indigestible components, said tablet containing an effective food preserving amount of natamycin.

37. A preserved food product according to claim 36 wherein said natamycin tablet is added directly to said food product.

38. A preserved food product according to claim 37 wherein said food product is selected from sour cream, wine, yoghurt, juice and other beverages, salad dressing, dips, confectionery fillings, bakery fillings, olive brine, olive oil, tomato purees and paste, condiments, fruit pulp, pet food and broiler feed.

39. A preserved food product according to claim 36 wherein said natamycin tablet is added indirectly to said food product.

40. A preserved food product according to claim 39 wherein said food product is selected from cheese, shredded cheese, processed cheese, cream cheese, cottage cheese, dried fermented meat product, such as salami and other sausages, confectionery, surface glazes and icing, bakery product, pizza toppings, and olives.
